(19) United States
(12) Patent Application Publication
(10) Pub. No.: US 2018/0021725 A1
(43) Pub. Date: Jan. 25, 2018

(54) CATALYSTS FOR ENHANCED REDUCTION OF NOx GASES AND PROCESSES FOR MAKING AND USING SAME

(71) Applicant: BATTELLE MEMORIAL INSTITUTE, Richland, WA (US)

(72) Inventors: Charles H. F. Peden, Rockville, MD (US); Feng Gao, Richland, WA (US); Yilin Wang, Richland, WA (US); Marton Kollar, Renens (CH); Janos Szanyi, Richland, WA (US)

(73) Assignee: BATTELLE MEMORIAL INSTITUTE, Richland, WA (US)

(21) Appl. No.: 15/721,139

(22) Filed: Sep. 29, 2017

Related U.S. Application Data
(63) Continuation of application No. 14/883,383, filed on Oct. 14, 2015.

(51) Int. Cl. B01D 53/86; B01D 53/94; B01J 37/08; B01J 37/02; B01J 29/76

(52) U.S. Cl. CPC B01D 53/8628; B01J 2229/186; B01J 37/0246; B01J 29/763; B01J 2229/183; B01D 2251/2062; B01D 2255/2045; B01D 2255/50; B01D 2255/20761; B01D 2255/204; B01D 2255/2047; B01D 2255/2025; B01D 2255/2027; B01D 2255/2042; B01D 2255/202; Y02C 20/10; B01J 37/08; B01D 2255/2022; B01D 53/9418

(57) ABSTRACT

Cu-exchanged zeolite catalysts with a chabazite structure containing selected concentrations of alkali ions or alkaline-earth ions and a lower concentration of (Cu) ions are described and a sequential process for making. Catalysts of the present invention reduce light-off temperatures providing enhanced low-temperature conversion of NOx gases. Catalysts of the present invention also exhibit high selectivity values compared to conventional NOx reduction catalysts.

### CROSS REFERENCE TO RELATED APPLICATION

This application is a Continuation of U.S. patent application Ser. No. 14/883,383 filed Oct. 14, 2015, which is hereby incorporated by reference in its entirety herein.

### STATEMENT REGARDING RIGHTS TO INVENTION MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### FIELD OF THE INVENTION

The present invention relates generally to catalysts for reducing NOx gases in emission streams. More particularly, the invention relates to chabazite zeolite catalysts with enhanced properties for reducing NOx gases in emission streams at low and high temperatures and processes for forming and using the catalysts.

### BACKGROUND OF THE INVENTION

Selective Catalytic Reduction (SCR) is a process of converting nitrogen oxide gases (known as NOx gases) present in emission streams such as flue gas streams or exhaust gas streams over oxide or synthetic zeolite catalysts into environmentally friendly gases such as diatomic nitrogen (N₂) and water (H₂O). The term chabazite (CHA) refers to natural or synthetic zeolites with a chabazite structure. The term “Chabazite structure” refers to the geometric shape and structure (framework) of the CHA crystals. CHA is easily synthesized, for example, as detailed by Robson (Verified Synthesis of Zeolitic Materials, Elsevier, 2001). SSZ-13 is a typical synthetic CHA zeolite not found in nature with Si/AI ratios ranging from unity to infinity. The CHA structure is a rhombohedral structure that consists of a sequence of stacked 6-member rings comprised of silicon (Si), aluminum (Al), and oxygen (O) positioned at each apex of the rhombic unit cell. CHA forms a type of cage with open channels that are confined by eight-membered rings. Open channels of the zeolite allow metal cations to move in and out of the zeolite. During SCR operation, reactive molecules move into the CHA channels and products such as N₂ and water to move out of the channels after formation. In the SCR process, a gaseous or vaporized liquid reductant such as anhydrous ammonia, aqueous ammonia, or urea introduced to the gas stream is adsorbed onto the CHA catalyst. For example, when urea is used as the reductant, the reductant hydrolyzes in the presence of water which generates ammonia and carbon dioxide (CO₂). Commercial-scale SCR systems now used on large utility boilers, industrial boilers, and municipal solid waste boilers can reduce NOx emissions by as much as 70% to 95%. More recently, a copper (Cu)-exchanged zeolite, [Cu]-SSZ-13, with a CHA structure has been developed that has a better NOx reduction capability and a better hydrothermal stability than other Cu-exchanged zeolites such as copper-exchanged ZSM-5 and beta zeolites. And, some reduction in light-off temperatures has been achieved by loading the CHA catalysts with (Cu) ions at concentrations exceeding 2% by weight. Consequently, Cu-exchanged CHA catalysts are used now as SCR catalysts to reduce NOx gases in diesel engine emissions in large ships, diesel locomotives, and some diesel automobiles. However, despite improvements in CHA catalysts to date, catalytic activity and selectivity of conventional Cu-exchanged CHA catalysts drop substantially at temperatures above 400° C. And, light-off temperatures for Cu-exchanged CHA catalysts critical for reduction of NOx gases in exhaust emissions still remain above about 170° C. Thus, current catalysts cannot meet increasingly stringent emissions requirements in lean-combustion powertrains, after-treatment systems, or for treatment of exhaust or emission streams at important temperature extremes. Accordingly, new catalysts are needed that provide suitable low-temperature and high-temperature NOx conversion activity. The present invention addresses these needs.

### BRIEF DESCRIPTION OF THE DRAWINGS

FIG. 1 illustrates a chabazite structure that forms the backbone of catalysts of the present invention.

FIGS. 2A-2B plot atomic NOx conversion efficiencies for fresh and hydrothermally aged catalysts of the present invention as a function of reaction temperature.

FIGS. 3A-3B compare NOx conversion selectivities ([NOx]/[NH₃]) for an exemplary catalyst of the present invention against a conventional copper-exchanged CHA catalyst.

FIG. 4 compares concentrations of N₂O gas in an emission stream as a function of reaction temperature for a conventional copper-exchanged CHA catalyst against a representative catalyst of the present invention

FIG. 5 illustrates an exemplary SCR catalytic reactor configured with catalysts of the present invention and process for reduction of NOx gases in exhaust systems.

### SUMMARY OF THE PRESENT INVENTION

The present invention includes modified Cu-exchanged chabazite zeolite SSZ-13 catalysts that provide enhanced catalytic activity and selectivity for reducing NOx gases in exhaust and emission streams at low light-off temperatures as low as 150° C. and enhanced conversion at high temperatures at or above 300° C. not presently obtained with conventional Cu-exchanged (>2% Cu ions by weight) SCR catalysts. Catalysts of the present invention also exhibit competitive activity and selectivity at standard SCR operation temperatures between about 200° C. to about 300° C. NOx conversion exceeds 90% on average.

Catalysts include an atomic ratio of silicon (Si) to aluminum (Al) selected between about 6 to about 40. Catalysts include an exchange loading of an alkali (Group-I) ion or an alkaline-earth (Group-II) ion between about 0.01% to at or below about 5% by weight; and an exchange loading of a copper ion between about 0.01% to at or below about 2% by weight.

In some embodiments, catalysts can provide light-off temperatures less than or equal to about 200° C. In some embodiments, catalysts can provide light-off temperatures less than or equal to about 150° C.

In some embodiments, catalysts can provide an atomic efficiency for reduction of NOx gases at least about 3 times greater than conventional copper-exchanged [(Cu) ion loading greater than 2% by weight] chabazite catalysts at temperatures at or below about 200° C.

In some embodiments, catalysts can provide an atomic efficiency for reduction of NOx gases greater than or equal to about 80% at a temperature at or below about 200° C.

In some embodiments, catalysts can provide NOx conversion selectivity values at least about 20% greater than conventional copper-exchanged chabazite catalysts (containing greater than 2% copper by weight) at temperatures at or above about 350° C. In some embodiments, catalysts can provide a NOx conversion selectivity at least about 100% better than conventional copper-exchanged chabazite catalysts at a temperature at or above of about 500° C.

In some embodiments, catalysts can provide a nitrogen (N₂) selectivity at or greater than about 97% at a temperature from about 200° C. to about 500° C.

The process of fabrication may include exchanging a synthetic copper-exchanged chabazite zeolite catalyst with an alkali (Group-I) ion or an alkaline-earth (Group-II) ion at a loading of between about 0.01% to at or below about 5% by weight; and subsequently exchanging the zeolite by ion exchange with a loading of copper ions between about 0.01% to at or below about 2% by weight. Catalysts formed by the sequential loading exhibit enhanced catalytic activity and selectivity at both low and high temperatures not observed with conventional Cu-exchanged CHA catalysts.

The process may include loading alkali (Group-I) ions selected from Li, Na, K, Rb, or Cs, or alkaline-earth (Group-II) ions selected from Mg, Ca, Sr, and Ba by ion exchange.

The loading may be performed sequentially by ion-exchange with a first ion-exchange medium containing the selected alkali or alkaline-earth ions and a second ion-exchange medium containing the copper ions, respectively.

The process may include drying the zeolite after each loading step at a selected temperature and calcining the sequentially loaded zeolite at a selected temperature to form the NOx conversion catalyst.

The present invention also includes a process for selective reduction of NOx gases. The process may include catalytically reducing NOx gases in an exhaust or emission stream to a preselected level over a synthetic Cu-exchanged zeolite catalyst containing a first exchange loading of an alkali (Group-I) ion or an alkaline-earth (Group-II) ion between about 0.01% to at or below about 5% by weight and a second exchange loading of a copper ion between about 0.01% to at or below about 2% by weight therein.

The process may include catalytic reduction of NOx gases over the NOx reduction catalyst at an atomic efficiency that is at least about 3 times greater at a temperature at or below about 200° C. than that obtained with a conventional copper-exchanged chabazite catalyst containing greater than 2% (Cu) ions by weight.

The process may include catalytic reduction of NOx gases over the NOx reduction catalyst at an atomic efficiency that is greater than or equal to about 80% at a temperature at or below about 200° C.

The process may include catalytic reduction of NOx gases that provides a NOx conversion selectivity of at least about 95% at a temperature selected between about 200° C. to about 500° C.

The process may include catalytic reduction of NOx gases over the NOx reduction catalyst provides a NOx conversion selectivity at least about 20% greater at a temperature at or above a temperature of about 350° C. than that obtained with a conventional copper-exchanged chabazite catalyst containing greater than 2% (Cu) ions by weight.

The process may include catalytic reduction of NOx gases over the NOx reduction catalyst that provides a NOx conversion selectivity at least about 100% better at a temperature at or above of about 500° C. than that obtained with a conventional copper-exchanged chabazite catalyst containing greater than 2% (Cu) ions by weight.

The catalytic reduction of NOx gases over the NOx reduction catalyst produces N₂O as a product gas at a concentration at or below about 5 ppm at a temperature at or below about 500° C.

The catalytic reduction of NOx gases over the NOx reduction catalyst reduces NOx gas in an exhaust or emission stream to a concentration at or below about 10 ppm on average at a temperature at or below about 500° C.

The catalyst may be a component of a NOx conversion reactor, a NOx catalytic conversion device or system, a NOx control system, or a vehicle exhaust device or system.

The purpose of the foregoing abstract is to enable the United States Patent and Trademark Office and the public generally, especially the scientists, engineers, and practitioners in the art who are not familiar with patent or legal terms or phraseology, to determine the nature and essence of the technical disclosure of the application. The abstract is neither intended to define the invention of the application, which is measured by the claims, nor is it intended to be limiting as to the scope of the invention in any way.

### DETAILED DESCRIPTION

New SCR catalysts and a process for fabrication are detailed. The catalysts provide enhanced catalytic activity and selectivity for removing NOx gases present in exhaust and emission streams at low and high temperature extremes. In the following description, embodiments of the present invention are shown and described by way of illustration of the best mode contemplated for carrying out the invention. It will be apparent from the description that the invention is susceptible of various modifications, alternative constructions, and substitutions without departing from the scope of the invention. The present invention is intended to cover all such modifications, alternative constructions, and equivalents falling within the spirit and scope of the invention as defined in the claims. Accordingly, the description of the preferred embodiments should be seen as illustrative only and not limiting.

### Catalysts of the Present Invention

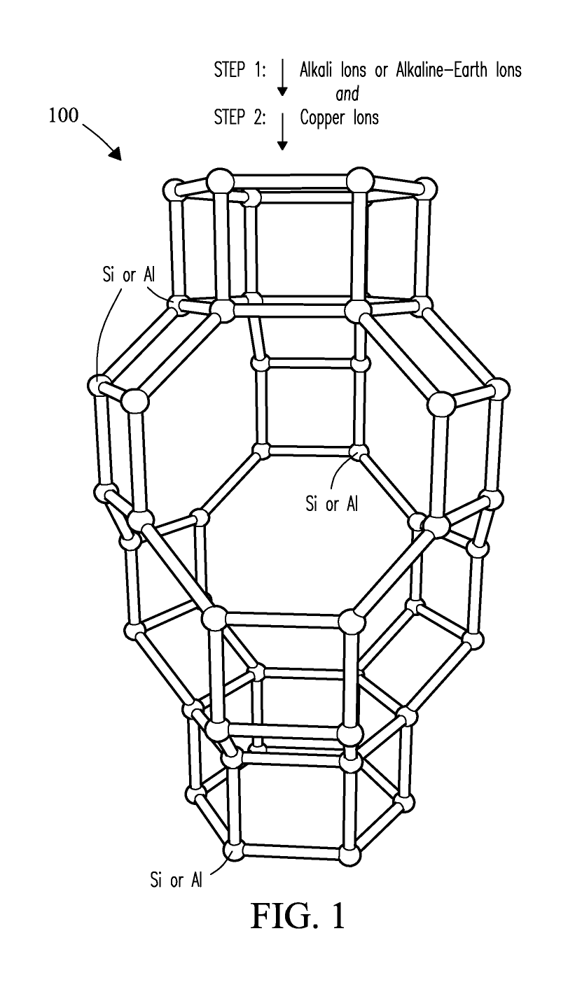

Catalysts of the present invention are porous synthetic zeolites comprised of a SSZ-13 material with a chabazite structure that are modified to include additional ions. FIG. 1 illustrates a chabazite (CHA) structure or framework 100 that forms the backbone of these catalysts. The chabazite structure forms with hexagonal unit cells containing 24 tetrahedral atoms of silicon (Si) and/or aluminum (Al), and 72 oxygen atoms positioned between the (Si) and/or (Al) atoms. Both (Si) and (Al) are tetrahedrally coordinated with oxygen (O) (not shown). The silicon-to-aluminum (Si/AI) ratio is selected between about 6 to about 40. The hexagonal unit cell includes a prism defined by a double 6-member ring positioned at the top end of the cell, and a CHA cage positioned at the bottom end of the structure containing six 8-membered rings called windows that can connect with other unit cells to form channels within the 3-dimensional CHA structure. The SSZ-13 zeolite is first modified by ion-exchange to include either alkali (Group-I) ions or alkaline-earth (Group-II) ions and further modified by sequential addition of copper (Cu) ions. Copper (Cu) ions (not shown) can occupy various extra framework positions. The term “extra framework” refers to an energetically favorable location for metal cations that balances the negative charges in the catalyst framework. Such positions often include, but are not limited to, for example, windows of 6-membered and 8-membered rings of the framework. (Cu) ions act as active sites within the catalyst. Alkali (Group-I) ions and alkaline-earth (Group-II) ions (e.g., Na⁺ and Ca²⁺) can also occupy various extra framework positions within the CHA windows or at positions slightly off the windows. In some embodiments, (Cu) ions and larger co-cations (e.g., K⁺ and Cs⁺) are positioned within the larger 8-membered windows. During operation, ions in the structure are partially solvated in the presence of moisture that renders them mobile. TABLE 1 lists concentrations of (Cu) ions and corresponding alkali ions and alkaline-earth ions (i.e., co-cations) in exemplary [Cu, M] SSZ-13 catalysts of the present invention. Here, (M) represents the alkali (e.g., Li, Na, K, Rb, and Cs) ions or the alkaline-earth (Ca, Mg, Sr, and Ba) ions present in the Cu-exchanged zeolite catalyst.

TABLE 1

| SSZ-13 | (Cu) ion Content | Co-cation Content |
|---|---|---|
| Catalyst | (wt %) | (wt %) |
| [Cu, Li] | 0.98 | 0.40 |
| [Cu, Na] | 0.98 | 1.78 |
| [Cu, K] | 0.94 | 4.21 |
| [Cu, Cs] | 0.62 | 14.95 |
| [Cu, Mg] | 0.71 | 1.14 |
| [Cu, Ca] | 0.96 | 2.28 |

Concentration of (Cu) ions in catalysts of the present invention may be selected between about 0.5% to at or below about 2% by weight. And, concentration of alkali (Group-I) ions or alkaline-earth ions in the catalysts may be selected between about 0.01% to about 5% by weight.

### Atomic Efficiency

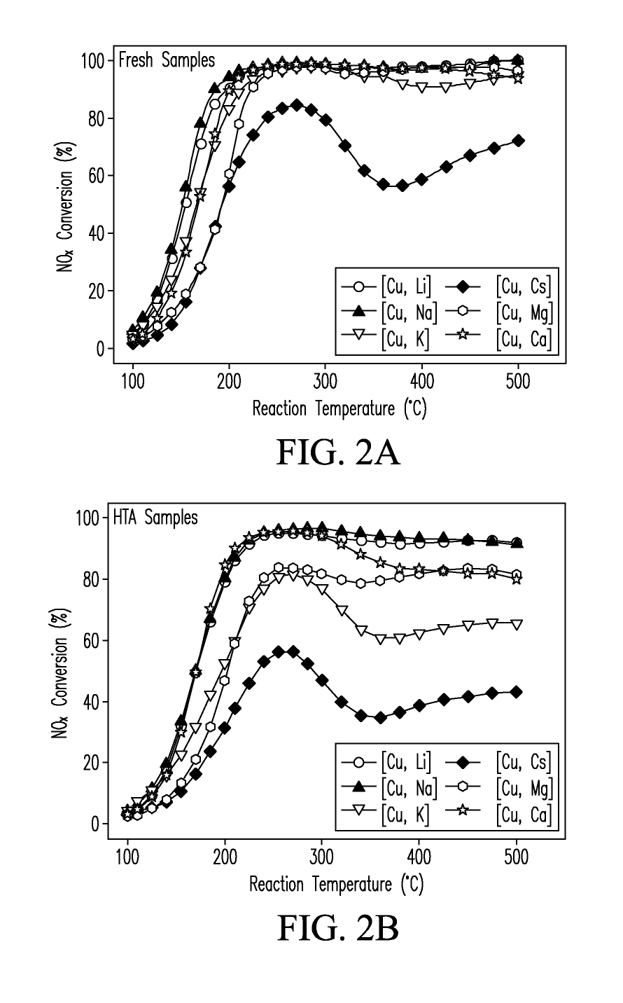

Atomic Efficiency is a measure of the NOx conversion obtained for a selected catalyst normalized to the copper ion content in the catalyst. FIG. 2A plots NOx conversion results for fresh catalysts of the present invention as a function of reaction temperature. Catalysts exhibit particularly superior results at low temperatures. For example, at a temperature of 200° C., atomic efficiency values for the best performing catalysts of the present invention are at least about 3 times greater for low-temperature NOx reduction compared to conventional Cu-exchanged CHA with a copper content of 2.4% by weight or greater.

Best performing catalysts containing Na⁺, Li⁺, and Ca²⁺ ions provide stable conversion of NOx gases above about 95% to about 100% on average over a full range of operation temperatures from above about 200° C. to about 500° C. or greater. A surprising result for these catalysts is the observation that NOx conversion does not decrease at high temperatures above 300° C. in contrast with conventional Cu-exchanged CHA catalysts, but continue to provide steady conversion at temperatures between 300° C. to about 500° C. or greater. For example, the [Cu (0.94%), K (4.21%)] potassium-exchanged SSZ-13 catalyst shows a slight decline in conversion performance to about 93% at temperatures between about 350° C. to about 450° C., but converts NOx gases at or better than 95% above 450° C. By comparison, the conventional Cu-exchanged CHA catalyst (2.4% Cu ions) shows a decline in performance above a temperature of 450° C., with a conversion performance of only about 90% at a temperature of 500° C. Results further demonstrate that (Cu) ions in catalysts of the present invention are also more catalytically selective, as evidenced by higher selectivity values detailed further herein.

These catalysts also exhibit lower light-off temperatures compared to conventional Cu-exchanged CHA catalysts and conventional Cu-exchanged CHA catalysts containing additional co-cations.

In general, catalysts of the present invention prepared by sequential ion-exchange exhibit superior catalytic properties compared with conventional Cu-exchanged CHA catalysts, or Cu-exchanged CHA catalysts containing simultaneously loaded co-cations.

FIG. 2B plots NOx conversion results for hydrothermally aged (HTA) catalysts of the present invention as a function of reaction temperature. Catalysts were hydrothermally aged by passing air containing about 10% water vapor through the catalyst bed heated at a temperature of 750° C. for 16 hrs. Aging simulates properties expected for the catalyst after a useful lifetime of several years in a catalytic converter or other exhaust system. Catalysts aged at a high temperature mimic effects of slow deactivation of catalysts over time in operation. At temperatures at or below about 200° C., catalysts of the present invention provide better than 80% conversion of NOx gases. By comparison, conversion of NOx gases by the conventional aged Cu-exchanged CHA catalyst (2.4% Cu ions by weight) decreases to below 10% on average at a temperature of 200° C.

At typical SCR operation temperatures between about 200° C. to about 300° C., NOx conversion results for aged catalysts of the present invention vary. Best performing aged catalysts include aged [Cu (0.98%), Li (0.40%)] SSZ-13 catalyst, aged [Cu (0.98%), Na (1.78%)] SSZ-13 catalyst, and aged [Cu (0.96%), Ca (2.28%)] SSZ-13 catalyst exhibit nearly identical performance, with NOx conversion values exceeding 95%.

Aged catalyst [Cu (0.94%), K (4.21%)] SSZ-13 exhibits an intermediate NOx conversion of between about 60% to about 75% on average over the same temperature range, with a NOx conversion of about 65% at 500° C.

Aged catalyst [Cu (0.71%), Mg (1.14%)] SSZ-13, and aged catalyst [Cu (0.94%), K (4.21%)] SSZ-13 exhibit intermediate NOx conversion results of between about 60% to about 83% on average over the same temperature range. Aged [Cu (0.62%), Cs (14.95%)] SSZ-13 catalyst exhibited a NOx conversion value of between 30% to 45% over the same temperature range, and about 45% at 500° C.

At high temperatures at or above 300° C. to 500° C., NOx conversion results for aged catalysts of the present invention vary by catalyst. Best performing catalysts including aged catalyst [Cu (0.98%), Na (1.78%)] SSZ-13 and aged catalyst [Cu (0.98%), Li (0.40%)] SSZ-13 exhibit nearly identical NOx conversion values at or above about 90% over this temperature range. Conventional Cu-exchanged CHA catalyst has a NOx conversion below 90% at 500° C. Aged catalyst [Cu (0.96%), Ca (2.28%)] SSZ-13 and aged catalyst [Cu (0.74%), Mg (1.14%)] SSZ-13 have a NOx conversion performance between about 78% to about 95% over this temperature range, with a NOx conversion of about 80% at 500° C. By comparison, the Cu-exchanged CHA catalyst has a maximum conversion of about 85% at 350° C., but performance decreases below 80% above this temperature, and down to about 75% at 500° C.

In general, catalysts of the present invention prepared by sequential ion-exchange exhibit superior catalytic properties compared with conventional Cu-exchanged CHA catalysts and Cu-exchanged CHA catalysts simultaneously exchanged with Group-I and Group-II ions by conventional ion exchange.

### Light-Off Temperature

A good qualitative measure of low-temperature activity of a catalyst is the so-called “light-off” (T₅₀ or T-50) temperature. Light-off temperature represents the lowest temperature at which a catalyst achieves a 50% conversion of NOx gases. NOx conversion values usually beginning at a low conversion value at the catalyst light off temperature to high values (often 100%) within a very narrow temperature range. TABLE 2 compares catalyst “light-off” (T₅₀ or T-50) temperatures for selected fresh and aged catalysts of the present invention against a conventional Cu-exchanged CHA catalyst.

TABLE 2

| | Catalyst | | | | | | |
|---|---|---|---|---|---|---|---|
| | [Cu] | [Cu, | [Cu, | [Cu, | [Cu, | [Cu, | [Cu, |
| | CHA * | Na] | Li] | K] | Ca] | Mg] | Cs] |
| Fresh | 174 | 151 | 154 | 166 | 168 | 193 | 193 |
| Aged | 212 | 170 | 170 | 196 | 170 | 203 | 234 |

* Conventional Cu-exchanged CHA catalyst with 2.4% Cu ions by weight.

As shown in the table, best performing fresh catalysts include [Cu (0.98%), Li (0.40%)] SSZ-13 and [Cu (0.98%), Na (1.78%)] SSZ-13 containing Li⁺ and Na⁺ ions with light-off temperatures near 150° C. Catalysts [Cu (0.94%), K (4.21%)] SSZ-13 and [Cu (0.96%), Ca (2.28%)] SSZ-13 containing K+ and Ca²⁺ ions have light-off temperatures at or below about 160° C. Catalysts [Cu (0.74%), Mg (1.14%)] SSZ-13 and [Cu (0.62%), Cs (14.95%)] SSZ-13 containing Mg²⁺ and Cs⁺ ions have light-off temperatures at or below about 180° C. By comparison, the conventional Cu-exchanged CHA catalyst with a 2.4% loading of (Cu) ions exhibits a light-off temperature of about 174° C. for the fresh catalyst and 212° C. for the aged catalyst.

Best performing aged catalysts exchanged with Na or Li ions have light-off temperatures at or below about 170° C. By comparison, the Cu-exchanged CHA catalyst exhibits a light-off temperature at about 212° C. by comparison. Catalysts that include addition of K or Ca also provide a significant reduction in the light-off temperatures compared to the conventional Cu-exchanged CHA catalyst. Results show light-off temperatures for fresh catalysts and aged catalysts of the present invention are reduced by as much as 25° C., and 43° C., respectively compared to the Cu-exchanged CHA catalyst.

Results show sequentially exchanged catalysts of the present invention reduce light-off temperatures. Light-off temperatures may be reduced by as much as 25° C. for fresh catalysts and as much as 40° C. or better for aged catalysts as compared to Cu-exchanged CHA catalysts with a high (>2%) loading of (Cu) ions.

### Catalyst Selectivity

“NOx Conversion Selectivity” measures or assesses the effectiveness of a particular catalyst to convert NOx gases by reacting with a reductant such as NH₃. “N₂ selectivity” measures or assesses the effectiveness of a particular catalyst to convert NOx gases to environmentally safe product N₂. Selectivity of catalysts is a function of three competing NOx conversion reactions:

4NOₓ+4NH₃+O₂=4N₂+6H₂O [1]

4NH₃+3O₂=2N₂+6H₂O [2]

4NOₓ+4NH₃+2O₂=4N₂O+6H₂O [3]

Reaction [1] represents the desired reaction that produces environmentally safe product gases. Reaction [2] is a competing side reaction that causes over-consumption of the reductant NH₃. Reaction [3] is a competing side reaction that yields N₂O gas, an undesired greenhouse gas.

NOx conversion selectivity may be calculated as the ratio of the NOx conversion (i.e., concentration of NOx converted to product gases) given by Equation [4] to the NH₃ conversion (i.e., concentration of NH₃ or equivalent reductant converted to product gases) given by Equation [5] used to reduce the NOx gas to product gases, as follows:

$$\begin{matrix}{NO}_{x} Conversion \% = \frac{{( NO + {NO}_{2} )}_{inlet} - {( NO + {NO}_{2} + {N}_{2} O )}_{outlet}}{{( NO + {NO}_{2} )}_{inlet}} \times 100 & [ 4 ] \\ {NH}_{3} Conversion \% = \frac{{( {NH}_{3} )}_{inlet} - {( {NH}_{3} )}_{outlet}}{{( {NH}_{3} )}_{inlet}} \times 100 & [ 5 ]\end{matrix}$$

As will be appreciated by those of ordinary skill in the art, a NOx conversion selectivity value close to 100% demonstrates that the catalyst is highly effective at catalyzing reactions between NOx gas and reductant NH₃. N₂ selectivity may be calculated as the ratio of the quantity of NOx converted to N₂ over the to the total NOx conversion. An N₂ selectivity value close to 100% means NOx gas in an emission stream is converted by the catalyst to N₂ gas with a low concentration of N₂O gas formed as a byproduct.

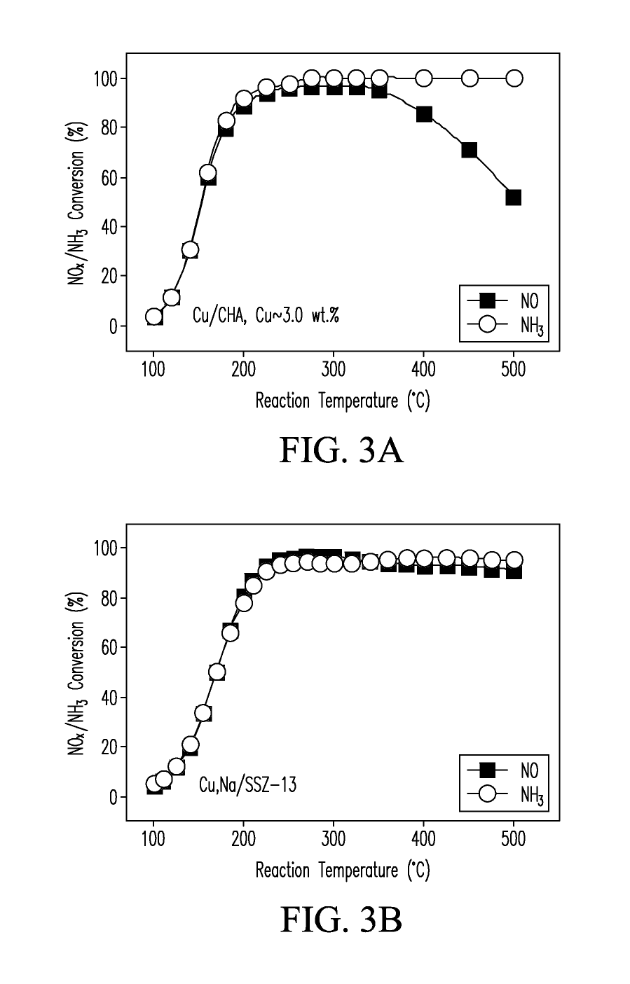

FIGS. 3A and 3B plot NOx conversion selectivity values for an exemplary aged [Cu (˜1%), Na (˜1%)] SSZ-13 catalyst of the present invention against an aged Cu-exchanged CHA catalyst (Si/Al=12.5, Cu loading ˜3.0%) as a function of reaction temperature. All catalysts of the present invention performed similarly. The [Cu,Na] SSZ-13 catalyst exhibits a NOx conversion selectivity above 85% and maintains steady catalytic NOx conversion over a wide temperature range from about 200° C. to about 500° C. or greater. By comparison, the Cu-exchanged CHA catalyst exhibits a NOx conversion selectivity of about 80% over a narrow temperature range from about 200° C. to about 300° C. However, above 300° C., NOx conversion decreases dramatically for the conventional catalyst reaching a NOx conversion selectivity of about 45% at a temperature of 500° C. Results show catalysts of the present invention exhibit higher selectivity values compared to Cu-exchanged CHA catalysts on average.

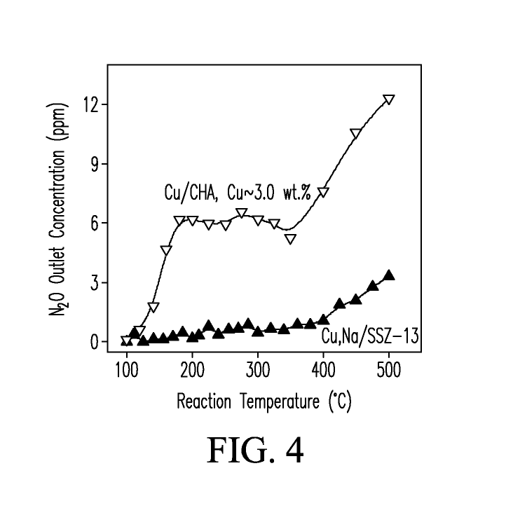

FIG. 4 compares the concentration of N₂O product gas released during NOx conversion over the exemplary aged [Cu (˜1%), Na (˜1%)] SSZ-13 catalyst of the present invention compared to the aged Cu-exchanged CHA catalyst (Cu loading ˜3.0%) as a function of reaction temperature. In exemplary tests, catalysts of the present invention produced N₂O gas at a concentration below about 3 parts-per-million (ppm) over a temperature range from about 400° C. to about 500° C., and at a concentration below about 1.5 ppm over a temperature range from about 300° C. to about 400° C., and at a concentration below about 1 ppm over a temperature range from about 100° C. to about 300° C. Other catalysts of the present invention perform similarly. By comparison, the conventional aged Cu-exchanged CHA catalyst generated a N₂O concentration of 12 ppm at a temperature of 500° C., a N₂O concentration of between about 6 ppm to about 12 ppm at temperatures between about 350° C. to about 500° C., a N₂O concentration of about 6 ppm at temperatures between about 200° C. to about 500° C., and a N₂O concentration of about 6 ppm at a temperature below 200° C.

Results show catalysts of the present invention exhibit a substantially better NOx conversion selectivity, N₂ selectivity, and a better atomic efficiency compared to conventional Cu-exchanged catalysts suitable for enhanced emission control in engines and other lean-burning systems.

### Applications

Catalysts of the present invention find application for enhanced stripping of NOx gas from exhaust and emission streams from diesel and gasoline-powered engines, vehicles incorporating diesel and gasoline-powered engines, SCR catalytic NOx gas converters and emission scrubbing systems deployed in vehicles, and other NOx gas conversion systems and like applications. While applications in vehicles will now be described, the present invention is not intended to be limited thereto.

### Exemplary SCR Catalytic Conversion Reactor

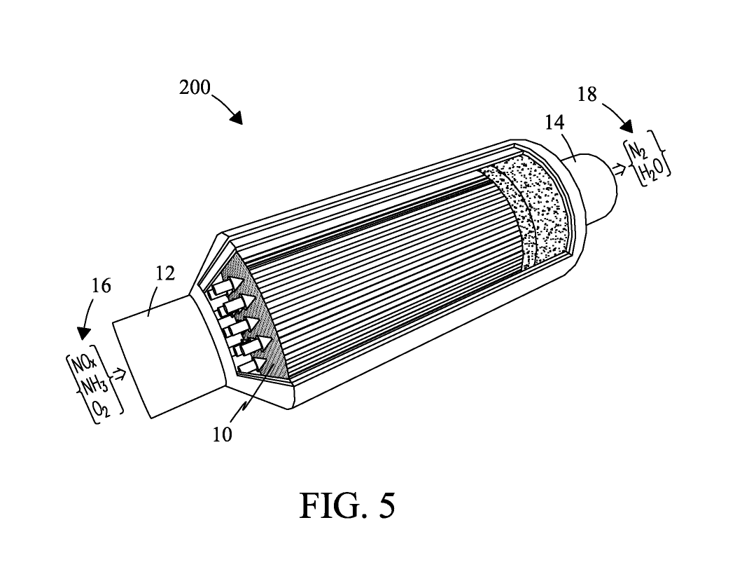

FIG. 5 illustrates an exemplary SCR catalytic converter 200 loaded with catalysts of the present invention and a process for conversion and reduction of NOx gases from emission streams. In the figure, catalytic converter 200 includes a solid ceramic support 10 such as cordierite, but supports are not intended to be limited. In the figure, ceramic support 10 includes a honeycomb type construction, but is not limited thereto. Catalysts of the present invention (not shown) may be loaded onto the ceramic support, for example, by wash-coating the support with the selected catalyst. The catalyst may be sintered to adhere the catalyst to the ceramic support.

During SCR operation, NOx gases present in an exhaust gas stream 16 containing other gases such as O2 may be mixed with a reductant gas such as ammonia (NH₃) and introduced to the NOx conversion reactor 200. NOx gases in exhaust stream 16 may be introduced into conversion reactor 200 through an inlet 12 where the NOx gas is converted over catalyst(s) present on the ceramic support 10 by the reaction of Equation [1] described previously, producing environmentally friendly release gases 18 including, for example, N₂ gas and H₂O vapor. Release gases 18 may be released through an outlet 14 from conversion reactor 200.

Catalysts of the present invention reduce NOx gases to levels that meet EPA regulations for emission gases. As detailed herein, catalysts of the present invention further provide lower light-off temperatures suitable for lower temperature operation. In a typical operation, NOx gases present in emission streams at concentrations of, for example, ˜300 ppm on the inlet 12 side of the catalytic converter 200 are converted over catalysts of the present invention to a concentration of less than about 10 ppm on the outlet 14 side of the catalytic converter 200.

### EXAMPLES

The following examples provide a further understanding of the present invention.

### Example 1

### Synthesis of [Cu, Na]-SSZ-13 Zeolite Catalyst

EXAMPLE 1 details synthesis of selected [Cu, M] SSZ-13 catalysts by ion-exchange. A SSZ-13 chabazite zeolite was synthesized in the Na⁺ ion form (i.e., [Na]-SSZ-13). First, a gel was prepared with the following composition [6]:

10SDA:10NaOH:xAl₂O₃:100SiO₂:2200H₂O [6]

Here, (x) may vary from 2 to 10 to allow different Si/Al ratios. The gel was prepared by first dissolving 1.5 g NaOH (e.g., 99.95% NaOH, Sigma-Aldrich Corp., St. Louis, Mo., USA) in water, and sequentially adding: 17.5 g of a structure-directing agent (SDA) such as adamantammonium hydroxide (TMAda-OH) (e.g., ZeoGen 2825, Sachem Inc., Austin, Tex., USA); adding 1.5 g (for Si/Al=12) Al(OH)₃ that contains ˜54% Al₂O₃ by weight (Sigma-Aldrich); and adding 12 g fumed silica (e.g., 0.007 μm average particle size) (Sigma-Aldrich). The mixture was vigorously stirred to form a homogeneous gel. The formed gel was then sealed into a TEFLON®-lined stainless steel autoclave (e.g., 125 mL autoclave) that contained a stir bar. The autoclave was placed in a sand bath on top of a hot plate stirrer and continuously stirred at 160° C. for 96 h to synthesize a uniform and crystallized [Na]-SSZ-13 material. After synthesis, the [Na]-SSZ-13 material was separated from the mother liquid via centrifugation, washed with deionized water 3 times, and dried at 120° C. under a flowing N₂ gas. The [Na]-SSZ-13 zeolite material was then calcined in air at a temperature selected between about 550° C.-650° C. for 8 h to remove SDA from the material. Quantity of (Si) and (Al) in the product powder was measured by Inductively Coupled Plasma Atomic Emission Spectroscopy (ICP-AES).

### Example 2

### Synthesis of Various [Cu,M]-SSZ-13 Catalysts

Various catalysts of the present invention were prepared as follows. The base [Na]-SSZ-13 zeolite of EXAMPLE 1 was fully exchanged with an aqueous ion-exchange medium, typically a 0.1 M NH₄NO₃ solution, to form the [NH₄⁺]-SSZ-13 zeolite. In a typical process, 1 g of the [Na]-SSZ-13 material was ion-exchanged with 1 L of a 0.1 M NH₄NO₃ solution at 80° C. for 8 h to form the ammonium-exchanged zeolite material, designated [NH₄]-SSZ-13. Next, the NH₄⁺-exchanged zeolite was exchanged with ion-exchange solutions containing selected quantities of an alkali (A) ion (where A=Li, Na, K, Rb, or Cs) or an alkaline-earth (AE) ion (where AE=Mg, Ca, Sr, or Ba) to form a single A or AE-exchanged SSZ-13 material. In a typical process, 1 g of [NH4]-SSZ-13 zeolite material was then stirred into 1 L of an ion-exchange medium containing, for example, 0.1M alkali nitrate [e.g., LiNO₃, KNO₃, CsNO₃] or alkaline-earth nitrate solutions [e.g., Mg(NO₃)₂ and Ca(NO₃)₂] that deliver Li⁺, K+, Cs⁺, Mg²⁺ or Ca²⁺ ions into the zeolite at 80° C. for 1 h. To ensure complete exchange of the selected ion into the zeolite (i.e., designated as a [M]-SSZ-13 material, where M is the selected alkali ion or alkaline-earth ion), the ion exchange process was typically repeated once. Next, the resulting A-exchanged or AE-exchanged zeolite ([M]-SSZ-13) material was collected, for example, by centrifugation and washed with deionized water. Exchanged material was then dried in air at 120° C. and calcined in air at 550° C. for 5 h as described in EXAMPLE 1. Next, each [M]-SSZ-13 material was then exchanged with a selected quantity of copper (Cu) ions (about 0.5 to about 2.0% of the final material in weight) to form the sequentially exchanged [Cu,M]-SSZ-13 material, where M is the alkali metal or alkaline-earth ion, where M=Li, Na, K, Cs, Mg and Ca. In a typical process, 1 g of the [M]-SSZ-13 material was introduced, for example, by stirring into 160 mL of a 0.001M CuSO₄ ion-exchange medium at 80° C. for 1 hr to obtain an exchange loading of, for example, ˜1.0 wt % (Cu) ions in the product zeolite. The sequentially ion-exchanged material was then collected, for example, by centrifugation, washed with deionized water, dried in air at 120° C., and calcined at 550° C. in air for 8 h to form a fresh [Cu,M]-SSZ-13 catalyst. Catalysts were active after calcination.

### Example 3

### Hydrothermal Aging of [Cu, M] SSZ-13 Catalysts for Lifetime Tests

Fresh [Cu,M]-SSZ-13 catalysts of EXAMPLE 2 were hydrothermally aged. 1 g of the selected catalyst was loaded into a quartz tube reactor. A flow of air containing 10% water vapor was flowed through the catalyst bed in the reactor at a flow rate of about 200 mL/min at 750° C. at a temperature of 750° C. for 16 hr to form the aged [Cu,M] SSZ-13 catalysts used in selected tests described herein.

### Example 4

### NOx Reduction Tests

SCR reaction tests were carried out using a plug-flow reaction system. Catalyst samples (120 mg, 60-80 mesh powders) were loaded in a 1 cm O.D. quartz tube placed inside an electric tube furnace. Temperature control and temperature measurements were achieved with a K-type thermocouple inserted into the catalyst bed. Gas lines were heated to over 100° C. to avoid water condensation. Feed gas containing 350 ppm NO, 350 ppm NH₃, 14% O₂, 2.5% H₂O and balance N₂. Total gas flow was 300 sccm. Gas hourly space velocity (GHSV) was estimated to be ˜100,000 h⁻¹. Tests temperatures range from 100° C. to 500° C. or even higher. Concentrations of reactants and products were measured by an online Nicolet Magna 560 FTIR spectrometer equipped with a 2 meter gas cell maintained at 150° C.

### Example 5

### Light-Off Temperatures

For alkali and alkaline-earth modified catalysts of the present invention, T-50 values were measured. T-50 values were: [Cu, Na]-SSZ-13 catalyst=151° C.; [Cu, Li]-SSZ-13 catalyst=154° C.; [Cu, K]-SSZ-13 catalyst=166° C.; [Cu, Ca]-SSZ-13 catalyst=168° C.; [Cu, Cs]-SSZ-13 catalyst=193° C.; and [Cu, Mg]-SSZ-13 catalyst=193° C. The conventional Cu-exchanged CHA catalyst (2.4% or greater loading of (Cu) ions) gave a T-50 of ˜174° C. for the fresh catalyst and 212° C. for the aged catalyst. Results show catalysts of the present invention can provide T-50's near 150° C., which represent a significant and considerable improvement to results obtained with the conventional Cu-exchanged CHA catalyst.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the scope of the present invention.

What is claimed is:

1. A modified NOx reduction catalyst that contains less than 2 percent copper metal by weight in a synthetic chabazite zeolite incorporating at least one material selected from the group consisting of Na, Li, K and Ca and provides a light off temperature less than 175° C., the catalyst produced by the process of:
fabricating a synthetic chabazite zeolite in sodium form;
exchanging the sodium therein with NH4+ ions forming a NH4-exchanged chabazite zeolite;
exchanging the NH4+ ions in the NH4-exchanged chabazite zeolite with a single alkali or alkaline-earth element and calcining same to secure the alkali or alkaline-earth element in active sites therein forming a fully alkali (A⁺) or alkaline-earth (AE⁺⁺)-exchanged chabazite zeolite;
exchanging a quantity of the alkali or alkaline-earth element in the alkali (A+) or alkaline-earth (AE++)-exchanged chabazite zeolite with copper to obtain a loading of copper metal above zero percent to at or below 2 percent by weight therein; and hydrothermally aging the copper-exchanged chabazite zeolite to stabilize the catalyst.

2. A process for fabricating a modified NOx reduction catalyst that provides a light off temperature less than 175° C., the process comprising:
fabricating a synthetic chabazite zeolite in sodium form;
exchanging the sodium therein with NH4+ ions forming a NH4-exchanged chabazite zeolite;
exchanging the NH4+ ions in the NH4-exchanged chabazite zeolite with a single alkali or alkaline-earth element and calcining same to secure the alkali or alkaline-earth element in active sites therein forming a fully alkali (A⁺) or alkaline-earth (AE⁺⁺)-exchanged chabazite zeolite; and
exchanging a quantity of the alkali or alkaline-earth element in the alkali (A⁺) or alkaline-earth (AE⁺⁺)-exchanged chabazite zeolite with copper to obtain a loading of copper metal above zero percent to at or below 2 percent by weight therein.

3. The process of claim 2, further including the step of hydrothermally aging the copper-exchanged chabazite zeolite to stabilize the catalyst.

4. A process for fabrication of a NOx reduction catalyst that contains less between 0.01 and 2 percent copper metal by weight in a zeolite and provides a light off temperature less than or equal to about 175° C. the process comprising the steps of:
replacing the cations from a loaded synthetic chabazite zeolite with an alkali (Group-I) ion or an alkaline earth (Group-II) ion followed by exchanging a quantity of the newly loaded alkali or alkaline-earth ion copper ions to obtain a loading of copper metal greater than 0.01% and less than 2% by weight therein.

5. The process of claim 1, wherein the loading of copper metal in the zeolite is less than 1 percent by weight.

6. A modified NOX reduction catalyst that contains less than 2 percent copper metal by weight in a synthetic chabazite zeolite incorporating at least one material selected from the group consisting of Na, Li, K and Ca and provides a light off temperature less than 150° C.

7. The catalyst of claim 6 wherein the catalyst provides a nitrogen (N₂) selectivity at or greater than about 97% at a temperature from about 200° C. to about 500° C.
